(19) United States
(12) Patent Application Publication
(10) Pub. No.: US 2016/0169153 A1
(43) Pub. Date: Jun. 16, 2016

(54) Engine Piston

(71) Applicant: Caterpillar Inc., Peoria, IL (US)

(72) Inventors: Lucas Burger, Lafayette, IN (US); Andrew Palmer, Lafayette, IN (US); Brandon Bowditch, Lafayette, IN (US)

(73) Assignee: Caterpillar Inc., Peoria, IL (US)

(21) Appl. No.: 14/567,159

(22) Filed: Dec. 11, 2014

(51) Int. Cl. F02F 3/28; F02F 3/00

(52) U.S. Cl. CPC F02F 3/28; F02F 3/0069

(57) ABSTRACT

A piston for an internal combustion engine includes a piston body forming a crown portion and a skirt portion. The skirt portion includes a pin bore and forms two guide surfaces. The crown portion forms a cylindrical surface having at least two grooves defining a top land surface and a bottom land surface. A ratio between a height of the top land surface and a nominal inner diameter of a bore in which the piston is configured to operate is between 3% and 4.5%. Further, the pin bore has a diameter that extends entirely within the respective heights of the two guide surfaces along the centerline of the piston such that the skirt portion fully supports the piston.

### TECHNICAL FIELD

This disclosure relates generally to internal combustion engines and, more particularly, to pistons operating within engine bores.

### BACKGROUND

Internal combustion engines typically include one or more pistons interconnected by connecting rods to a crankshaft. The pistons are typically disposed to reciprocate within bores formed in a crankcase. A typical piston includes a head portion, which at least partially defines a combustion chamber within each bore, and a skirt, which typically includes a pin opening and other support structures for connection to the connecting rod of the engine. In general, a piston is formed to have a generally cupped shape, with the piston head forming the base, and the skirt portion being connected to the base and surrounding an enclosed gallery of the piston. In typical applications, lubrication oil from the engine is provided within the gallery of the piston during operation to convectively cool and lubricate various portions of the piston.

A typical piston head also includes an outer cylindrical wall having one or more circumferentially continuous grooves formed therein. These grooves typically extend parallel to one another and are appropriately sized to accommodate sealing rings therewithin. These sealing rings create sliding seals between each piston and the crankcase bore it is operating within. Typically, the groove located closest to the skirt of the piston accommodates a scrapper ring, which is arranged to scrape oil clinging on the walls of the piston bore during a down-stroke of the piston. Oil that may remain wetting the walls of the bore following the down-stroke of the piston may enter the combustion chamber and combust during operation of the engine.

In general, the piston operates by reciprocating within a bore formed in a cylinder case of the engine, which creates a variable volume that can compress a fuel/air mixture provided therein. The combusting fuel/air mixture expands and pushes the piston to increase the variable volume, thus producing power. Fuel can be provided directly or indirectly within the variable volume, while air and exhaust gas is provided or removed from the variable volume through one or more intake and exhaust valves that selectively fluidly connect the variable volume with intake and exhaust collectors.

The materials used to construct the walls of the engine cylinders, the piston, the various valves associated with the variable volume, and other surrounding engine structures, are selected to withstand high temperatures and pressures that are present during engine operation. Various features of the piston are also shaped to promote the efficient burning of fuel within the piston, reliability of the various engine components associated with the engine cylinders, and other considerations. However, it is always desired to increase the reliability and service life of these and other engine components, as well as promote the efficient operation of the engine in terms of reducing fuel consumption and emissions and increasing power and efficiency.

### BRIEF SUMMARY OF THE DISCLOSURE

In one aspect, the disclosure describes a piston for an internal combustion engine. The piston includes a piston body forming a crown portion and a skirt portion. The skirt portion includes a pin bore that is arranged to receive a pin for connecting the piston to a connecting rod. The skirt portion further forms two guide surfaces along outer margins of the skirt portion. The crown portion forms a generally cylindrical surface surrounding the crown portion. The generally cylindrical surface forms at least two grooves therein that extend parallel to one another. The at least two grooves define a top land surface, a bottom land surface, and at least one intermediate land surface along the generally cylindrical surface.

In one disclosed embodiment, the top land surface has a height in a direction along a centerline of the piston, and the piston has a nominal outer diameter that is configured to permit the piston to operate within a bore having a nominal inner diameter. A ratio between the height of the top land surface and the nominal inner diameter of the bore is between 3% and 4.5%. Further, each guide surface extends on an outer portion of the skirt portion over a height in the direction along the centerline of the piston, and the pin bore has a diameter that extends entirely within the respective heights of the two guide surfaces in the direction along the centerline of the piston, such that the skirt portion fully supports the piston during operation within a piston bore by counteracting forces and moments present in the piston and applied through the piston bore.

### BRIEF DESCRIPTION OF THE DRAWINGS

FIG. 1 is a fragmented view of a piston in accordance with the disclosure.

FIG. 2 is an outline view from a bottom perspective of the piston of FIG. 1.

FIGS. 3, 4 and 5 are enlarged fragmentary views of various portions of the piston of FIG. 1.

FIG. 6 is a fragmentary view of an alternative embodiment for a piston in accordance with the disclosure.

### DETAILED DESCRIPTION

This disclosure relates to pistons for use in internal combustion engines. In one aspect, the disclosure provides various embodiments for engine pistons having features that can set up flow fields and turbulence to promote combustion of fuel within the cylinder. Such features of the piston, depending on the type of engine operation, for example, spark ignition or compression ignition, can operate to contain, mix and/or direct various fuel containing masses within the piston to increase engine efficiency, decrease heat rejection, shorten burn time, and also control component temperatures, thus increasing component reliability and service life. As discussed herein, the mixing or directing of material within the cylinder may occur at least for an instant and may last no more than a few thousandths of a second while an injection of fuel and/or a combustion flame is present within the cylinder, or over portions of that period.

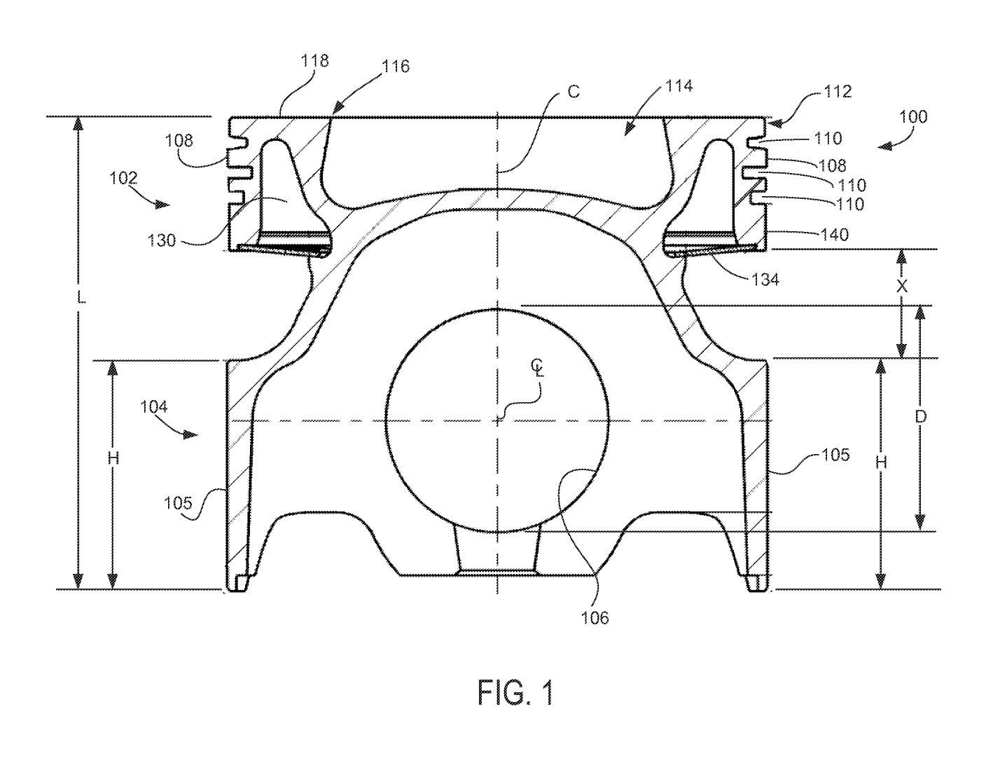

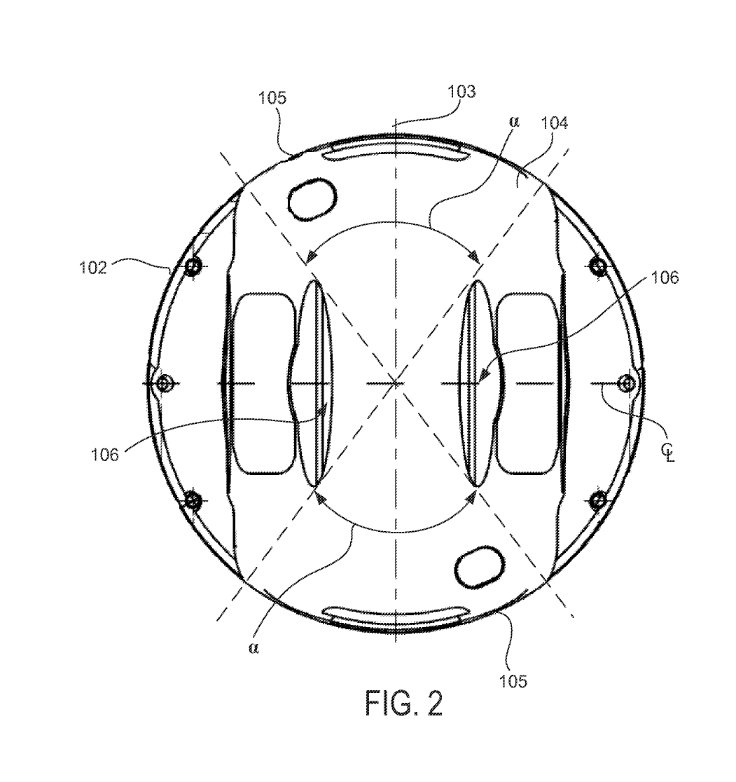

For purpose of illustration of certain features of an engine piston in accordance with the disclosure, a fragmented view of a piston 100 for an engine is shown from a side perspective in FIG. 1, and an outline view thereof from a bottom perspective is shown in FIG. 2. The piston 100 includes a crown portion 102 and a skirt portion 104. The skirt portion 104 forms a pin bore 106 that accommodates a pin (not shown) used to pivotally connect the piston to a connecting rod (not shown), which is connected to an engine crankshaft (not shown) in the known fashion. The skirt portion 104 further includes two guide surfaces 105 disposed on diametrically opposite sides of the piston 100. In an alternative embodiment, the guide surfaces may be integrated into a single guide surface extending substantially around the piston. In the illustrated embodiment, the two guide surfaces 105 extend at least along cross sections of the piston that include a piston cross section 103, which is shown in FIG. 1 and which is perpendicular to a centerline, C/L, of the pin bore 106, as shown in FIG. 2. On either side of the piston, the two guide surfaces 105 may extend over two angular portions of the periphery of the piston, each denoted by a in FIG. 2 and extending about between 70 and 90 degrees. In the illustrated embodiment, each angle α is about 77 degrees for a total of about 154 degrees of coverage around the piston 100.

In reference now to FIG. 1, each of the two guide surfaces 105 extends on an outer portion of the skirt portion 104 over a height, H, in a direction along a centerline, C, of the piston 100. In the illustrated embodiment, the diameter, D, of the pin bore 106 along the centerline C of the piston 100 at least partially overlaps the height, H, of the guide surface such that the skirt portion 104 partially supports the piston 100 during operation by counteracting forces and moments present in the piston between the connecting rod, via the pin disposed in the pin bore 106, and a piston bore into which the piston is disposed. In the illustrated embodiment, to provide full support to the piston, i.e., a full coverage of the pin bore 106, the piston includes a secondary guide surface 108, which is formed as the second land between piston ring grooves 110 formed in the peripheral, outer cylindrical wall 112 of the crown portion 102.

More specifically, the crown portion 102 includes piston ring grooves 110 in the outer cylindrical wall 112. The piston ring grooves 110 accommodate ring seals (not shown) that slidably and generally sealably engage the walls of the engine cylinder in which the piston 100 is reciprocally disposed. An outer diameter of the two guide surfaces 105 and the secondary guide surface 108 is arranged such that the piston is prevented from rotating or binding within the bore in which it is reciprocally disposed during operation. Moreover, the two guide surfaces 105 and secondary guide surface 108 collectively cover a length along the centerline, C, of the piston that entirely includes along the same direction the pin bore 106 such that full coverage is provided.

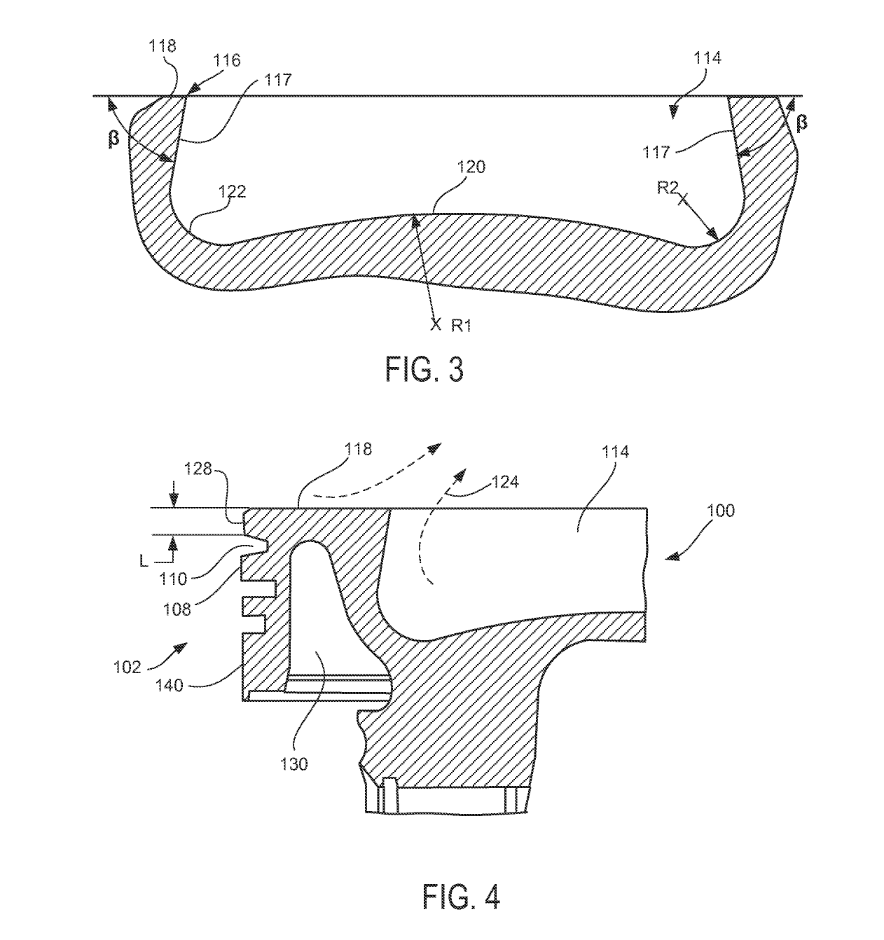

Regarding other functional features of the piston 100, in reference to the orientation of the piston 100 as shown in FIG. 1, the crown portion 102 forms a bowl 114 having generally a concave shape. The bowl 114 is surrounded by a rim 116. The rim 116 is centrally disposed relative to the centerline, C, and has a generally circular shape. An annularly shaped, flat, crown surface 118 is disposed around the rim 116 of the bowl 144. A detailed, enlarged view of the bowl 114 is shown in FIG. 3. As can be seen in FIG. 3, the bowl 114 forms a frusto-conical wall surface 117 adjacent the rim 116. The frusto-conical wall surface 117 surrounds the bowl 114 and is formed at an angle, β, of about 80 degrees with respect to the crown surface 118.

Around the center of the bowl is a convex surface 120 that is centrally disposed with respect to the piston 100. The convex surface 120 has a radius, R1, of about 155 mm, but other radii can also be selected. From a functional standpoint, the radius of the convex surface 120 determines the overall volume of the bowl 114, which in turn determines the volume of the combustion chamber when the piston is at the top dead center position within the bore and also the compression ratio of the engine. Thus, the radius R1 of the convex surface 120 can be selected depending on the desired compression ratio of the particular engine in which the piston is installed and will operate.

Surrounding the convex surface 120 and disposed within the frusto-conical wall surface 117 is a concave surface 122. The concave surface 122 is formed at a radius of about 10 mm and extends peripherally around the convex surface 120. In the illustrated embodiment, the rim 116 is relatively sharp or formed at a relatively small de-burr chamfer, for example, of about 0.25 mm or less. During operation, the piston 100 forms various features that operate to redirect and/or contain various moving masses within the cylinder. In various embodiments, these features operate to split the hot injector fuel plume that is provided to the cylinder when the piston is close to a top dead center position in the cylinder, and also which may be provided while the piston is approaching the top dead center position (e.g., pilot injection events) and/or is moving away from the top dead center position (e.g. post injection events during a combustion stroke). The fuel plume, a fuel atomization cloud, and/or a flame of burning fuel during these times of engine operation can be redirected in terms of flow direction and material dissipation in a fashion that reduces exposure of the various surrounding in-cylinder combustion surfaces to flame temperatures. By insulating cylinder surfaces from flame temperatures, retained heat and heat transfer to the metal of the surrounding engine components can be reduced, which in turn can provide a higher power output and/or higher power density to the engine, and also improve component reliability and service life. In the illustrated embodiment, the piston 100 achieves flow detachment along the crown surface 118 and material turbulation within the bowl 114 by the combined effects or primarily the frusto-conical wall surface 117 and the rim 116 having a sharp transition. These features operate to keep the burning fuel away from the edges of the piston.

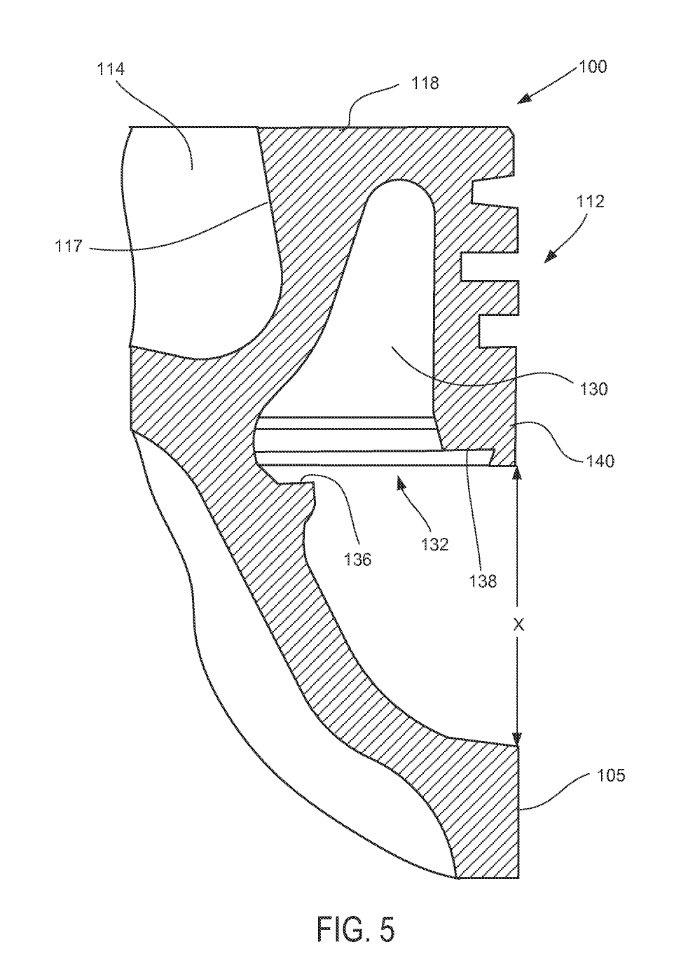

To illustrate an additional feature of the piston 100, an enlarged view of the crown portion 102 is shown in FIG. 4. In this figure, a cross section showing the edge of the bowl 114 is annotated with dashed-line arrows to show the direction of burning material motion during at least an instant of operation of the piston. In this illustration, a moving mass of burning fuel is turbulated or mixed within the bowl 114 in a region that generally follows a path 124. Surrounding air from within the combustion chamber is drawn in along a path 126. The combined effects of combustion that is, at least partially, provided by the various piston features described, enables a reduction in the height of the crown portion 102, in general, and the top land 128, in specific. The top land 128, as described herein, is a portion of the outer cylindrical wall 112 of the piston 100 that is disposed between the uppermost one of the piston ring grooves 110 and the crown surface 118. Traditionally, the height of the top land would be increased such that the topmost ring disposed in the topmost one of the piston ring grooves 110 would be further away from the heat generated during fuel burning within the cylinder. By setting up a flow field and turbulence to promote combustion within the cylinder, which results in a more complete fuel burn and a shortening in burn duration, along with other improvements in the materials and coatings used to manufacture the piston rings, the height of the top land 128, along with the dead volume it creates around the piston, can be reduced. In the illustrated embodiment, the top land has a height, L (FIG. 4), of a nominal dimension of about 6 mm, ±0.5 mm. The piston 100 has a nominal outer diameter (as measured at the skirt) that is consistent with a bore diameter of 170 mm. This means that the ratio between the top land height to the nominal diameter of the piston is about 3.5%, or within a range between 3% and 4.5%. It is also noted that an annular oil gallery 130, which is formed within the crown portion 102 between the outer cylindrical wall 112 and the bowl 114 (also see FIG. 1), helps remove heat generated at the bowl 114 and the crown surface 118 that would tend to migrate via conduction towards the topmost one of the piston ring grooves 110 and the ring disposed therein (not shown).

For forming the annular oil gallery 130, in the illustrated embodiment, machining tools are used to remove material from an original piston casting made of metal. An enlarged detail view of a portion of the piston 100 is shown in FIG. 5. As can be seen in FIG. 5, the gallery is open at one end along an opening 132, which is closed during operation by an annularly shaped, generally conical plate 134 (FIG. 1). The conical plate 134 is retained between an lower surface 136 and an upper surface 138 disposed on either side of the opening 132. Inside the gallery, various convex and concave surfaces are formed around the cavity volume to generally follow the shape of the external piston features such as the bowl 114, the crown surface 118, and the outer cylindrical wall 112. Below the opening 132 and between the two guide surfaces 105 and a lower-most land 140 is an axial distance, X, that is required for tool access when forming the annular oil gallery 130 through the opening 132. As is also shown in FIG. 1, the axial distance, X, at least partially overlaps with an upper end of the diameter D of the pin bores, which is why the two guide surfaces 105 can only partially support the piston and the secondary guide surface 108 must be used to fully support the piston. Moreover, the axial distance, X, also tends to increase the overall length, L, of the piston in a direction along the centerline, C, of the piston. The increase in overall length L of the piston 100, in turn, increases the mass of the piston and also increases the overall rotational moment of the engine crankshaft to which the piston is connected.

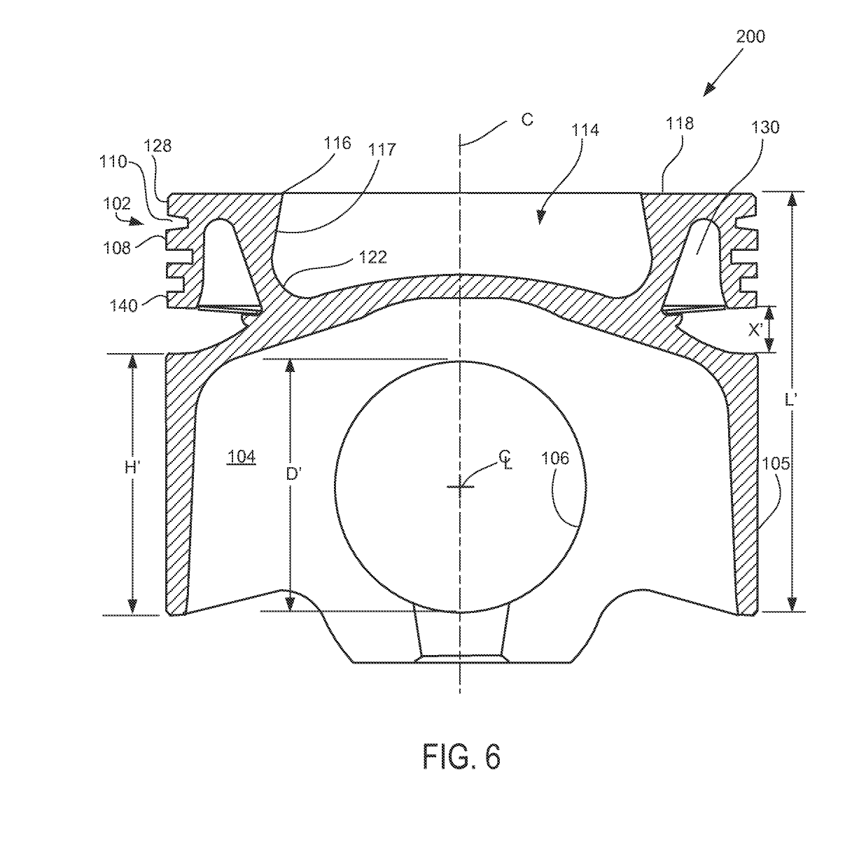

To alleviate these and other issues, an alternative design for a piston 200 is shown in FIG. 6. The piston 200 includes various structures and features that are the same or similar to corresponding structures and features of the piston 100 are denoted by the same or similar reference numerals and letters as previously used for discussion, but should not necessarily be understood as limiting the scope of the disclosure to those elements shown.

As can be seen in FIG. 6, the height H′ of the two guide surfaces 105 is longer than and completely covers or overlaps with the diameter, D, of the pin bore 106. This means that the skirt portion 104 of the piston 200 completely supports the pin bore 106 and additional support from the outer cylindrical wall 112 of the crown portion 102 is not required. Because no support from the outer cylindrical wall 112 or any of the lands disposed therein is required, the overall height of the outer cylindrical wall 112 can be reduced, as can the distance X′ between the outer cylindrical wall 112 and the two guide surfaces 105 can be reduced while still maintaining sufficient tool clearance for machining the annular oil gallery 130. In this way, the center of gravity of the piston 200 can move closer to the centerline C/L of the pin (not shown) disposed in the pin bore 106, the overall weight of the piston 200 can be reduced, as compared to the piston 100 (FIG. 1), and the rotational moment of inertia of the crankshaft of the engine in which the piston is installed can be reduced.

### INDUSTRIAL APPLICABILITY

The present disclosure is applicable to pistons for internal combustion engines, which can be used in any application such as land or marine based applications, as well as for mobile or stationary applications. The various embodiments for piston features described herein have been found to have advantages in improving engine operation by increasing power output, decreasing fuel consumption and also decreasing emissions.

In one analysis, the heat release rate of a cylinder as a function of crankshaft angle rotation in degrees (CAD), for three piston designs was considered. The three piston designs included a baseline piston, in which the bowl includes a peripherally extending wall surface that is shallow or, stated differently, the inclination angle of the baseline piston bowl that corresponds to the angle, β (see FIG. 3), was more than 90 degrees. The analysis further included a second, intermediate piston, in which the peripherally extending wall surface of the piston bowl was generally cylindrical or, stated differently, the inclination angle corresponding to the angle, β, was about 90 degrees. Finally, a third piston was considered, in which the angle, β, was about 80 degrees, as shown in the piston 100 illustrated, for example, in FIG. 3. The three pistons were otherwise operated at the same engine operating condition. Based on the analysis, it was determined that the peak instantaneous heat release rate (IHRR) increased dramatically as the angle, β, of the peripheral wall from a shallow angled interface, to a perpendicular transition, and then to a sharp, concave transition, which was unexpected.

More specifically, where the peak IHRR for the baseline piston was determined to be at about 0.032 (1/CAD), the peak IHRR for the second piston was at about 0.037, and for the third piston at about 0.042, which represents an increase of more than 30% in the IHRR for the cylinder from the baseline piston, which was unexpected. In other tests, a peak IHRR as high as 0.055 (1/CAD) was observed, which is about a 72% increase over the baseline piston. In this analysis, the test conditions for measuring the reported peak IHRR values were run on a gas, spark-ignited engine operating at 2220 kPa IMEP, generating about 180 ppm NOx, having an intake manifold absolute temperature of about 51 deg. C. (IMAT), and ignition timing at 24 deg. before top dead center (BTDC). It is contemplated that the increase in IHRR for the piston 100, as described herein, may be attributed to an increase in the so-called squish velocity, which describes the velocity of fluids within the cylinder in the area above the crown surface 118 (see FIG. 1), and which was measured at a maximum of 9.9 m/s for the baseline piston, 12.2 m/s for the intermediate piston, and 14.6 m/s, a 48% increase over the baseline, for the piston 100 (FIG. 1). However, it has been found that only a narrow workable range exists for improvements to IHRR based on the bowl design.

More particularly, it is difficult to realize efficiency benefit when the IHRR increases, because increasing squish velocity leads to increasing losses the cylinder air system such as air system breathing, heat transfer, and the like, which outweigh any benefit to engine efficiency because of IHRR increases. Similarly, slower squish velocities, which lead to lower IHRRs, can affect and are too low for high engine brake efficiencies. In general, engine efficiency tends to flatten off above IHRR of about 4.5%/CAD, while a re-entrant bowl design, such as the bowl design for the piston 100 (FIG. 1), can affect the maximum possible IHRR. It is noted that the piston 100, as shown in FIG. 1, provides an IHRR of between 4-4.5%/CAD.

Another feature of the piston 100 (FIG. 1) that has been found to affect engine operation, for example, in apparent heat release rate in the cylinder, is the sharpness of the piston bowl rim or edge radius, when the transition is formed as a chamfer, which is denoted by reference numeral 116, for example, in FIG. 1. In one analysis, the apparent heat release rate (AHRR) with respect to crank angle was measured for a baseline piston design, in which a rim radius for a chamfer transition was about 5 mm, an intermediate piston, in which a rim radius was about 2.5 mm, and a third piston, which corresponds to the piston 100 (FIG. 1), in which the rim radius was about 0.25 mm. For these pistons, the maximum AHRR for the baseline piston was about 0.84 kJ/CAD, the maximum AHRR for the intermediate piston was about 0.88 kJ/CAD, but the maximum AHRR for the piston in accordance with the present disclosure was, surprisingly, about 1.06 kJ/CAD, which represents an increase of about 26% over the baseline piston. It is believed that the sharper bowl edge, which exhibits higher combustion efficiency and improved knock or detonation margin in the cylinder, improved engine operation by also shortening the duration of fuel burn within the cylinder.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the disclosed embodiments (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this disclosure are described herein. Variations of those preferred embodiments may become apparent to those of ordinary skill in the art upon reading the foregoing description. Skilled artisans are expected to employ such variations as appropriate. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A piston for an internal combustion engine, comprising:
a piston body forming a crown portion and a skirt portion, the skirt portion including a pin bore that is arranged to receive a pin for connecting the piston to a connecting rod, the skirt portion further forming two guide surfaces along outer margins of the skirt portion, the crown portion forming a generally cylindrical surface surrounding the crown portion, the generally cylindrical surface forming at least two grooves therein that extend parallel to one another, the at least two grooves defining a top land surface, a bottom land surface, and at least one intermediate land surface along the generally cylindrical surface;
wherein the top land surface has a height in a direction along a centerline of the piston, wherein the piston has a nominal outer diameter configured to permit the piston to operate within a bore having a nominal inner diameter, and wherein a ratio between the height of the top land surface and the nominal inner diameter of the bore is between 3% and 4.5%;
wherein each guide surface extends on an outer portion of the skirt portion over a height in the direction along the centerline of the piston, and wherein the pin bore has a diameter that extends entirely within the respective heights of the two guide surfaces in the direction along the centerline of the piston such that the skirt portion fully supports the piston during operation within a piston bore by counteracting forces and moments present in the piston and applied through the piston bore.

2. The piston of claim 1, wherein the two guide surfaces are disposed on diametrically opposite sides of the piston and extend at least along cross sections of the piston that are perpendicular to a centerline of the pin bore.

3. The piston of claim 2, wherein each of the two guide surfaces extends over a respective angular portion of the periphery of the piston, which extends between about 70 and 90 degrees measured along a periphery of the piston.

4. The piston of claim 1, wherein the top land is shorter than the bottom land in the direction along the centerline of the piston.

5. The piston of claim 1, wherein the top land and the bottom land have about the same height.

6. The piston of claim 1, wherein the top land has a height of about 6 mm, ±0.5 mm.

7. The piston of claim 6, wherein the nominal inner diameter of the bore is 170 mm.

8. The piston of claim 1, wherein the piston has a nominal outer diameter at the skirt portion of about 169.9 mm.

9. The piston of claim 1, further comprising an oil gallery formed in the crown portion and having an annular shape.

10. The piston of claim 9, wherein the oil gallery extends within an outer wall that includes the generally cylindrical surface.

11. The piston of claim 10, wherein, during operation, the oil gallery is configured to accommodate engine oil therein, the engine oil operating to remove heat from the crown portion.

12. The piston of claim 9, wherein the oil gallery has an annular opening directed away from the crown surface, the annular opening being obstructed at least partially in the direction along, or parallel with, the centerline of the piston.

13. The piston of claim 12, wherein an axial distance is formed between the annular opening and the at least two guide surfaces of the piston in the direction along the centerline of the piston, the axial distance permitting machining tool access to form the oil gallery through the annular opening.

14. The piston of claim 13, wherein the axial distance does not overlap the pin bore in the direction along the centerline of the piston.

15. The piston of claim 14, wherein the two guide surfaces are disposed to fully support loading imparted to the piston through the pin bore during operation.
